(19) United States
(12) Patent Application Publication
(10) Pub. No.: US 2023/0237785 A1
(43) Pub. Date: Jul. 27, 2023

(54) Deep Learning Based Multi-Sensor Detection System for Executing a Method to Process Images from a Visual Sensor and from a Thermal Sensor for Detection of Objects in Said Images

(71) Applicant: NavInfo Europe B.V., Eindhoven (NL)

(72) Inventors: Shruthi Gowda, Eindhoven (NL); Elahe Arani, Eindhoven (NL); Bahram Zonooz, Eindhoven (NL)

(21) Appl. No.: 17/581,759

(22) Filed: Jan. 21, 2022

(51) Int. Cl. G06V 10/82; G06V 10/77; G06N 20/20

(52) U.S. Cl. CPC G06V 10/82; G06V 10/7715; G06N 20/20

(57) ABSTRACT

A Deep Learning based Multi-sensor Detection System for executing a method to process images from a visual sensor and from a thermal sensor for detection of objects in said images, wherein a first deep learning network for processing images from the visual sensor and a second deep learning network for pro-cessing images from the thermal sensor are jointly used and collaboratively trained for improving both networks ability to accurately detect said objects in said images.

### BACKGROUND OF THE INVENTION

### Field of the Invention

The invention relates to improving a Deep Learning based Multi-sensor Detection System for executing a method to process images from a visual sensor and from a thermal sensor for detection of objects in said images.

Such a Deep Learning based Multi-sensor Detection System is used to improve object recognition in images. Such Deep Learning technology, object detection, forms the core of autonomous driving systems and uses the images from the sensor to detect multiple objects such as vehicles, pedestrians, and obstructions. These predictions are used to make significant decisions in real-time and hence need to be highly accurate and consistent during all times of day, seasons, weather, and other external influences.

A problem in such object recognition in images is that Low lighting, adverse weather conditions such as rain and snow or other effects such as glare due to high beam, leads to the decline in the image quality of the visual cameras. Hence, while the object detection networks achieve high accuracy during daytime and good illumination conditions, variation in these factors leads to degradation in the performance.

### Background Art

K. Agrawal and A. Subramanian, “Enhancing object detection in adverse conditions using thermal imaging,” arXiv preprint arXiv:1909.13551, 2019 proposed a trained network using both RGB and thermal data. This approach did not provide much improvement in overall accuracy.

R. Yadav, A. Samir, H. Rashed, S. Yogamani, and R. Dahyot, “Cnn based color and thermal image fusion for object detection in automated driving,” Irish Machine Vision and Image Processing, 2020 proposed an architecture to fuse visual and thermal images for detection where the features from two networks are extracted and merged in the last convolution layer before feeding it to the decoder for detection. This two-stream network is computationally expensive and the simple fusion logic falls short in complex data scenarios.

C. Li, D. Song, R. Tong, and M. Tang, “Illumination-aware faster r-cnn for robust multispectral pedestrian detection,” Pattern Recognition, vol. 85, pp. 161-171, 2019 proposed to fuse RGB and Thermal data at different layers on the network but these methods require paired images from both modalities at inference which limits their application.

All the above approaches do simple fusion to get one representation from two different data having different distributions. This leads to suboptimal performance.

Note that this application refers to a number of references. Such references are not to be considered as prior art vis-a-vis the present invention. Discussion of such references herein is given for more complete background and is not to be construed as an admission that such references are prior art for patentability determination purposes.

### BRIEF SUMMARY OF THE INVENTION

Embodiments of the present invention are directed to a first deep learning network for processing images from the visual sensor and a second deep learning network for processing images from the thermal sensor are jointly used and collaboratively trained for improving both networks ability to accurately detect the objects in said images. In other words: The Deep Learning based Multi-sensor Detection System of the invention learns from data from at least two different sensors by jointly and collaboratively training the at least two deep learning networks, one on images from a visual camera sensor and another on thermal data from a thermal sensor to improve an object detector's performance across varying lighting and weather conditions. The visual images used in this computer implemented method provide detailed visual cues which are complemented by the thermal images which offer semantic information of objects that might be occluded or less visible in the corresponding visual image. The invention thus integrates the data from the visual and thermal sensors to train the detection system that produces consistent detections irrespective of the ambient lighting or weather.

Favourably the first deep learning network for pro-cessing images from the visual sensor and the second deep learning network for processing images from the thermal sensor receive visual data and thermal data, respectively, that are derived from the same scene. This promotes the flexibility for each network to incorporate complementary knowledge from the other modality without impeding its ability to learn the optimal representation on the modality it is trained on.

In a preferred embodiment a mimicry loss is determined between the first deep learning network for processing images from the visual sensor and the second deep learning network for processing images from the thermal sensor, and used for improving the accuracy of both said networks. The mimicry loss is used to align the feature spaces of both networks and helps in each network learning complementary knowledge of the data from the other network, while a supervised loss helps in retaining the knowledge of each network's own data.

Further it is preferred that an overall loss function for each of the first network and second network is determined which is represented by the sum of the mimicry loss and the supervised detection loss of the first network and second network, respectively.

Advantageously each of the first network and the second network comprises an encoder and a detection head for localization and classification of objects in the images, wherein both the first network and the second network are provided with a decoder taking features from intermediate layers of the encoder to reconstruct the images. Reconstruction is an auxiliary task that aids in extracting from the data all the semantic information into learned representation. Accordingly, the method of the invention is encouraged to explore the input feature space exhaustively and extract all the semantic information into the learned representations.

There are several options to reconstruct the inputs.

In one embodiment the decoder for the visual images takes features from the encoder for the visual images, and the decoder for the thermal images takes features from the encoder for the thermal images. As an auxiliary task this reconstruction aids in extracting from the data all the semantic information into learned representation.

In another embodiment the decoder for the visual images takes features from the encoder for the thermal images, and the decoder for the thermal images takes features from the encoder for the visual images. Such cross reconstruction learns to use semantic information from thermal data to reconstruct visual images, thus disentangling the features to learn effective representations.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The invention will hereinafter be further elucidated with reference to the drawing of an exemplary embodiment of a MultiModal Framework according to the invention to combine data from different sensors to provide a reliable and comprehensive detection system that is not limiting as to the appended claims. The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawing:

FIG. 1 shows an example of visual images derived from a prior art detection system for objects in such images;

FIG. 2 shows an example of images derived from a detection system according to an embodiment of the present invention for objects in such images;

FIG. 3 shows a schematic representation of a multimodal framework according to an embodiment of the present invention;

FIG. 4 shows a schematic representation of a multimodal framework according to an embodiment of the present invention completed with a regular reconstruction facility; and

FIG. 5 shows a schematic representation of a multimodal framework according to an embodiment of the present invention completed with a cross reconstruction facility.

Whenever in the figures the same references or reference numerals are applied, these references or reference numerals refer to the same parts.

### DETAILED DESCRIPTION OF THE INVENTION

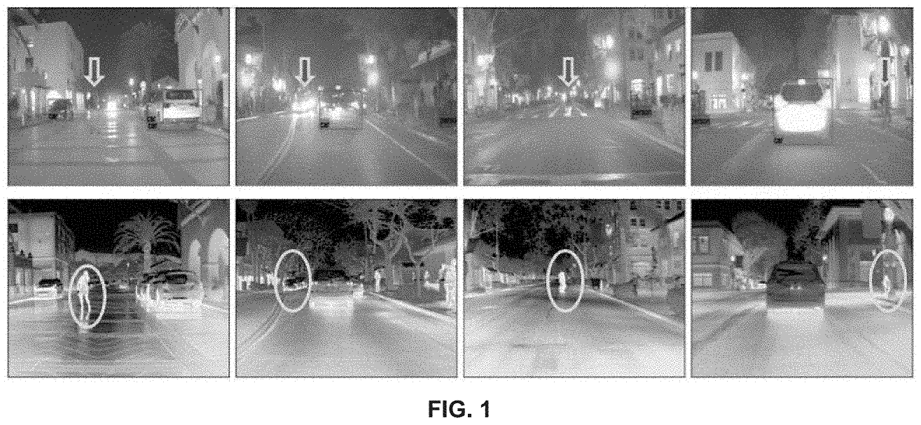

FIG. 1 shows that visual images derived from a prior art detection system for objects is such images, suffer from the problem that pedestrians and vehicles that are masked due to the headlight beam are not clearly visible (and hence not predicted) when using just visual images, but they are very clearly seen in the corresponding thermal images. The shown images are images from the FLIR dataset, see: Teledyne FLIR https://www.flir.eu/oem/adas/adas-dataset-form/, 2018. In FIG. 1, the pedestrians obscured and missed in RGB images but seen clearly in thermal images.

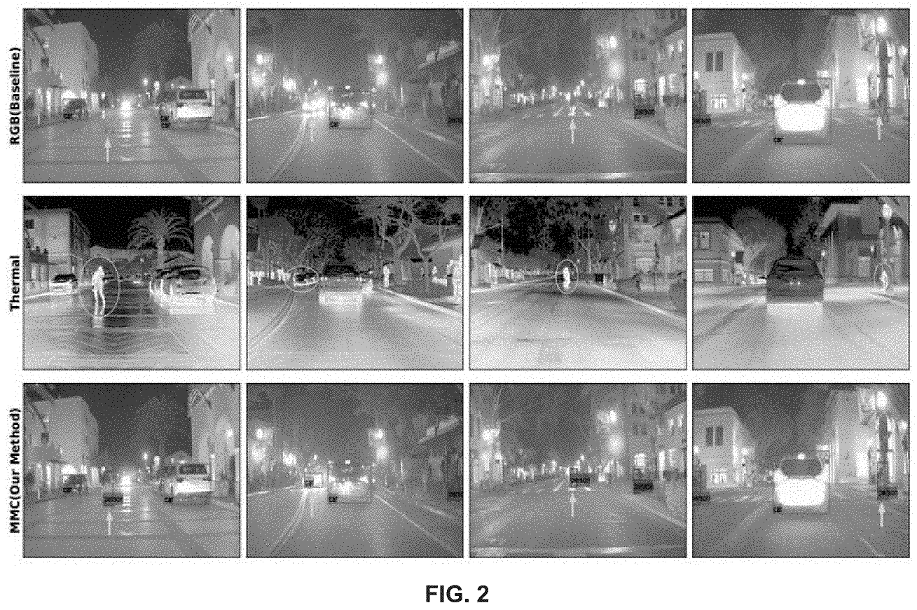

FIG. 2 shows an example of images derived from a detection system according to an embodiment of the present invention for objects in such images. The visual information is integrated with thermal information which helps in detecting people and vehicles in difficult scenarios. Again, these images are taken from the above-mentioned FLIR dataset. The invention of addition of thermal data helps in detecting pedestrians and cars that are not clearly visible due to lighting and headlight glares as highlighted in yellow.

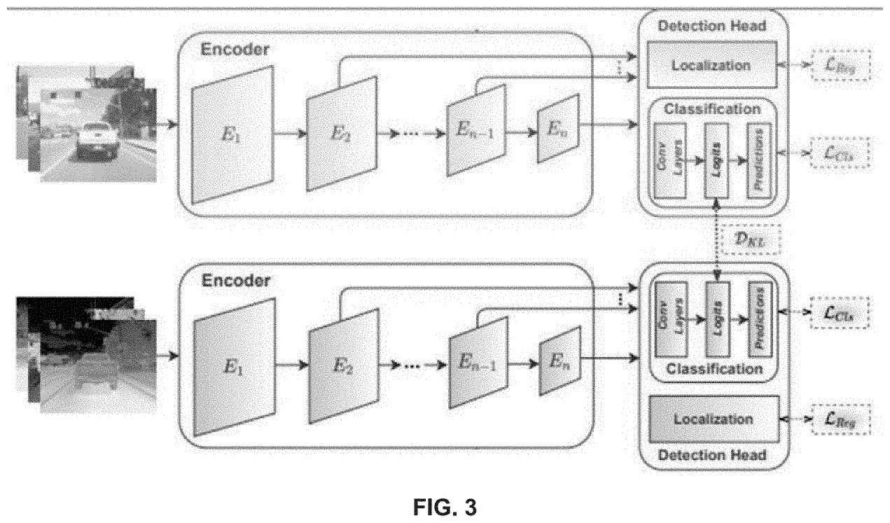

FIG. 3 shows the scheme according to which a Deep Learning based Multi-sensor Detection System is set up for executing a method to process images from a visual sensor and from a thermal sensor for detection of objects in said images, wherein a first deep learning network for processing images from the visual sensor and a second deep learning network for processing images from the thermal sensor are jointly used and collaboratively trained for improving both networks ability to accurately detect said objects in said images. FIG. 3 is a schematic of MMC with RGB network (red-hue) and Thermal network (grey-hue).

With reference to FIG. 3, a MultiModal-Collaborative (MMC) framework is depicted with two networks that are trained in a collaborative manner. As an example the data from the visual sensor are referred to as RGB data. The RGB-network is provided on the upper part of the figure and receives the RGB images while the thermal-network, which is shown below the RGB network, receives the corresponding thermal images as the input. The Collaborative training framework provides flexibility for each network to learn complementary knowledge from the other modality without impeding its ability to learn on the modality it is predominantly trained on. Each network is trained with a supervised detection loss and for the mimicry loss, the Kullback—Leibler (KL) divergence is used.

The overall loss function per network is the sum of detection loss and the mimicry loss. The KL divergence (D_{KL}) is applied on the soft logits p_{rgb} and pₜₕₘ. λ_{rgb} and λₜₕₘ are the balancing weights.

[symbol]

_{MMC}−RGB= [symbol] [symbol] ₑₜ+λ_{rgh} [symbol] _{KL}(p_{rgb}∥pₜₕₘ)

[symbol]

_{MMC}−Thm= [symbol] [symbol] ₑₜ+λₜₕₘ [symbol] _{KL}(pₜₕₘ∥p_{rgb})

The detection loss is a weighted summation of classification and regression losses:

$${ℒ}_{Det} = \frac{1}{{N}_{Cls}} {ℒ}_{Cls} + {λ}_{Reg} {ℒ}_{Reg}$$

To further encourage the method according to an embodiment of the present invention to explore the input feature space exhaustively and extract all the semantic information into the learned representations, an auxiliary task for reconstructing the inputs can be applied. The auxiliary task network takes in the features from the intermediate layers of encoders and aims to reconstruct the input image via the decoders. Hence, each of the first network and the second network comprises an encoder and a detection head for localization and classification of objects in the images, and both the first network and the second network are provided with a decoder taking features from intermediate layers of the encoder to reconstruct the images. There are two possible embodiments:
MMC+Reconstruction
MMC+Cross Reconstruction

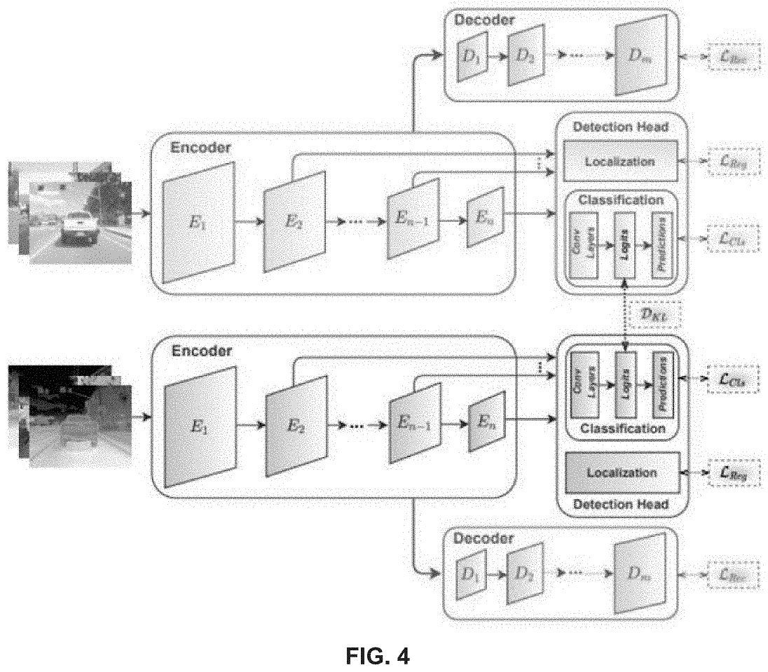

In the first embodiment providing MMC+Reconstruction, the decoder for the visual images takes features from the encoder for the visual images, and the decoder for the thermal images takes features from the encoder for the thermal images. This shows FIG. 4, which is a schematic of MMC with Reconstruction (Decoders are shown in blue-hue). The reconstruction Loss for each network is shown below. x_{rgb} and xₜₕₘ are the inputs, Enc and Dec denote the Encoder and the Decoder used for feature extraction and reconstruction respectively.

[symbol]

_{Rec-RGB}=Σ(x_{rgb}−Dec_{rgb}(Enc_{rgb}(x_{rgb}))²

[symbol]

_{Rec-Thm}=Σ(xₜₕₘ−Decₜₕₘ(Encₜₕₘ(xₜₕₘ))²

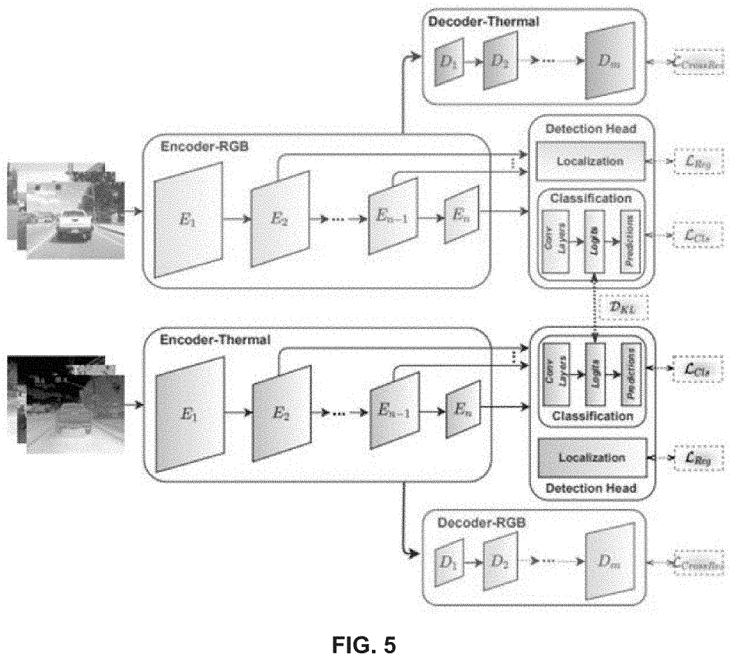

FIG. 5 shows an alternative embodiment, wherein the decoder for the visual images takes features from the encoder for the thermal images, and wherein the decoder for the thermal images takes features from the encoder for the visual images. FIG. 5 is a Schematic of MMC with Cross Reconstruction. The encoder and decoder are thus of different modality. This encourages the backbone to disentangle texture and semantic features and learn to utilize the semantic features from a thermal image to reconstruct the corresponding RGB image. For the downstream task, the detection head selects the relevant semantic features and this helps in domain adaptation as the semantic features remain the same during different lighting conditions. The cross-reconstruction Loss for each network in this modality is shown below.

[symbol]

_{CrossRec-RGB}=Σ(x_{rgb}−Dec_{rgb}(Encₜₕₘ(xₜₕₘ))²

[symbol]

_{CrossRec-Thm}=Σ(xₜₕₘ−Decₜₕₘ(Enc_{rgb}(x_{rgb}))²

Optionally, embodiments of the present invention can include a general or specific purpose computer or distributed system programmed with computer software implementing steps described above, which computer software may be in any appropriate computer language, including but not limited to C++, FORTRAN, BASIC, Java, Python, Linux, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

Although the invention has been discussed in the foregoing with reference to exemplary embodiments of the Deep Learning based Multi-sensor Detection System of the invention, the invention is not restricted to these particular embodiments which can be varied in many ways without departing from the invention. The discussed exemplary embodiments shall therefore not be used to construe the appended claims strictly in accordance therewith. On the contrary the embodiments are merely intended to explain the wording of the appended claims without intent to limit the claims to these exemplary embodiments. The scope of protection of the invention shall therefore be construed in accordance with the appended claims only, wherein a possible ambiguity in the wording of the claims shall be resolved using these exemplary embodiments.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

1. A Deep Learning based Multi-sensor Detection System for executing a method to process images from a visual sensor and from a thermal sensor for detection of objects in said images, wherein a first deep learning network for processing images from the visual sensor and a second deep learning network for processing images from the thermal sensor are jointly used and collaboratively trained for improving both networks ability to accurately detect said objects in said images.

2. The Deep Learning based Multi-sensor Detection System of claim 1, that learns from data from at least two different sensors by jointly and collaboratively training two deep learning networks, one on images from a visual camera sensor and another on thermal data from a thermal sensor to improve an object detector's performance across varying lighting and weather conditions.

3. The Deep Learning based Multi-sensor Detection System of claim 1, wherein the first deep learning network for processing images from the visual sensor and the second deep learning network for processing images from the thermal sensor receive visual data and thermal data, respectively, that are derived from the same scene.

4. The Deep Learning based Multi-sensor Detection System of claim 1, wherein a mimicry loss is determined between the first deep learning network for processing images from the visual sensor and the second deep learning network for processing images from the thermal sensor, and used for improving the accuracy of both said networks.

5. The Deep Learning based Multi-sensor Detection System of claim 4, wherein the mimicry loss is used to align the feature spaces of both networks and helps in each network learning complementary knowledge of data from the other network, while a supervised loss helps in retaining the knowledge of a network's own data.

6. The Deep Learning based Multi-sensor Detection System of claim 4, wherein an overall loss function for each of the first network and second network is determined which is represented by the sum of the mimicry loss and the supervised detection loss of the first network and second network, respectively.

7. The Deep Learning based Multi-sensor Detection System of claim 1, wherein each of the first network and the second network comprises an encoder and a detection head for localization and classification of objects in the images, and that both the first network and the second network are provided with a decoder taking features from intermediate layers of the encoder to reconstruct the images.

8. The Deep Learning based Multi-sensor Detection System of claim 7, wherein the decoder for the visual images takes features from the encoder for the visual images, and wherein the decoder for the thermal images takes features from the encoder for the thermal images.

9. The Deep Learning based Multi-sensor Detection System of claim 7, wherein the decoder for the visual images takes features from the encoder for the thermal images, and wherein the decoder for the thermal images takes features from the encoder for the visual images.
